(19) United States
(12) Patent Application Publication
(10) Pub. No.: US 2019/0217842 A1
(43) Pub. Date: Jul. 18, 2019

(54) Air Treatment Unit for a Brake System of a Utility Vehicle, Brake System and Method for Operating an Air Treatment Unit

(71) Applicant: KNORR-BREMSE Systeme fuer Nutzfahrzeuge GmbH, Muenchen (DE)

(72) Inventors: Andreas LEINUNG, Muenchen (DE); Max MICHALSKI, Neubiberg (DE)

(21) Appl. No.: 16/358,877

(22) Filed: Mar. 20, 2019

Related U.S. Application Data
(63) Continuation of application No. PCT/EP2017/071273, filed on Aug. 24, 2017.

(30) Foreign Application Priority Data
Sep. 21, 2016 (DE) 10 2016 117 837.3

(51) Int. Cl. B60T 17/00; B60T 13/66; B60T 13/68

(52) U.S. Cl. CPC B60T 17/004; B60T 17/04; B60T 13/683; B60T 13/662

(57) ABSTRACT

An air treatment unit for a brake system of a utility vehicle includes a control valve connection for pneumatically coupling the air treatment system to at least one control valve connected upstream of a wheel brake cylinder of the brake system that is configured to alter a brake pressure in the wheel brake cylinder, a supply valve for supplying the control valve connection with a required pressure, and a control device for controlling the supply valve.

### CROSS REFERENCE TO RELATED APPLICATIONS

This application is a continuation of PCT International Application No. PCT/EP2017/071273, filed Aug. 24, 2017, which claims priority under 35 U.S.C. § 119 from German Patent Application No. 10 2016 117 837.3, filed Sep. 21, 2016, the entire disclosures of which are herein expressly incorporated by reference.

### BACKGROUND AND SUMMARY OF THE INVENTION

The present invention relates to an air control unit for a brake system of a commercial vehicle, to a brake system, and to a method for operating an air control unit.

A commercial vehicle can have a brake system which can be controlled automatically by an electronic brake system. In the case of a failure of the electronic brake system, the automatic control of the brake system can be maintained, for example, by way of redundant control electronics with a separate power supply.

Against this background, the approach which is proposed here proposes an air control unit for a brake system of a commercial vehicle, a brake system, a method for operating an air control unit, and a corresponding computer program in accordance with the main claims. Advantageous developments and improvements of the apparatus which is specified in the independent claim are possible by way of the measures which are indicated in the dependent claims.

An air control unit for a brake system of a commercial vehicle is proposed, the air control unit having the following features:
a control valve connector for coupling the air control unit pneumatically to at least one control valve which is connected upstream of a wheel brake cylinder of the brake system for changing a brake pressure in the wheel brake cylinder;
a loading valve for loading the control valve connector with a setpoint pressure; and
a control unit for actuating the loading valve.

An air control unit can be understood to mean a unit for purifying or drying air for operating the brake system. For example, the air control unit can be an electronic air control unit (EAC). A commercial vehicle can be understood to be, for example, a truck, an omnibus, a tractor unit or a mobile crane. For example, the commercial vehicle can be a vehicle which strives in a partially or fully automated manner. The commercial vehicle can be equipped, for example, with an anti-lock brake system (ABS) or an electronic brake system (EBS). A control valve can be understood to be a purge valve of the anti-lock brake system, for instance in the form of a solenoid valve. The control valve can be arranged, for example, in the vicinity of the wheel brake cylinder. A loading valve can be understood to be a valve module comprising one or more valve units. For example, the loading valve can be realized as a solenoid valve module with at least two solenoid valve units. Depending on the embodiment, the loading valve can additionally have a relay valve for modulating a setpoint pressure. A setpoint pressure can be understood to be an operating pressure for operating the brake system or else a control pressure for changing a valve position of a valve of the brake system. On account of its pneumatic system, the relay valve can normally modulate approximately the same pressure with a greater flow cross section which exists at its control inlet. To this extent, the relay does not increase the pressure level, but rather permits the control of greater volumetric flows in this context, as are required in the wheel brake cylinders but cannot be provided via the solenoid valves. A control unit can be understood to be an electric unit which processes sensor signals and outputs control and/or data signals in a manner which is dependent on said sensor signals. The control unit can have an interface which can be configured using hardware and/or software. In the case of a hardware configuration, the interfaces can be, for example, part of what is known as a system ASIC which comprises a very wide variety of functions of the control unit. It is also possible, however, that the interfaces are dedicated, integrated circuits or consist at least partially of discrete components. In the case of a software configuration, the interfaces can be software modules which are present, for example, on a microcontroller in addition to other software modules.

The approach which is proposed here is based on the finding that a control valve which is connected upstream of a wheel brake cylinder of the brake system can be loaded with a pressure in parallel with an electronic brake system by an air control unit of a brake system, it being possible for the pressure to be applied upstream of the control valve. In the context of autonomous driving, a redundant brake system can therefore be realized which can brake in an active manner independently of driver interventions, even in the case of a failure of the electronic brake system. Thus, for example, brake forces can be distributed in an optimum manner between the axles of the commercial vehicle in a manner which is dependent on a load-induced contact force, as a result of which as short a braking distance as possible can be achieved.

In accordance with one embodiment, the control unit can be coupled or can be capable of being coupled to at least one wheel speed sensor of the commercial vehicle, and can be configured to actuate the loading valve or, in addition or as an alternative, the control valve with the use of a wheel speed sensor signal which is generated by the wheel speed sensor. A wheel speed sensor can be understood to be, for example, a pole wheel sensor. The wheel speed sensor signal can represent a rotational speed of an individual wheel of the commercial vehicle. Said embodiment makes targeted braking of individual wheels of the commercial vehicle by the air control unit possible. As a result, it can be avoided that the wheels of the commercial vehicle lock during braking.

Here, the control unit can be configured to actuate the loading valve or, in addition or as an alternative, the control valve with the use of the wheel speed sensor signal in such a way that the commercial vehicle is controlled in an optimum manner at the slip limit (ABS braking) or else is braked on one side. As a result of the braking on one side, a steering/braking function can be realized using the air control unit, which steering/braking function can stop the vehicle safely not only in a braking manner, but rather also in a steering manner, in the case of a failure of an electric steering system and/or in the case of the driver being unfit to drive.

In accordance with a further embodiment, the loading valve can have a solenoid valve and a relay valve which can be actuated pneumatically by the solenoid valve to modulate the setpoint pressure. The control unit can be configured to actuate the solenoid valve. A relay valve can be understood to be a valve with a pressure inlet, a pressure outlet and a control inlet for controlling a throughflow between the pressure inlet and the pressure outlet with the use of a control pressure.

Here, the solenoid valve can be configured in a bistable manner. This has the advantage that the control valve connector can be loaded with the setpoint pressure even in the case of an interruption of a power supply of the control unit. One embodiment of the approach which is proposed here would also be advantageous, in the case of which a group comprising electromagnetic and pneumatic valves can also be configured in a bistable manner, in order to advantageously also be suitable for actuating a parking brake cylinder and therefore for switching on an electric parking brake, not only on the rear axle.

In accordance with a further embodiment, the air control unit can have a distributor unit for distributing air which is controlled by the air control unit to at least one brake circuit which is assigned to a service brake of the brake system and to at least one connecting line for connecting the distributor unit to the control valve connector. In particular, the loading valve can be configured for actuating the service brake via a shuttle valve with a first shuttle valve inlet and a second shuttle valve inlet, in order to superimpose the outlet control pressure of a front axle valve module and/or an outlet control pressure of the foot brake module at the second shuttle valve inlet. The loading valve can be arranged in the connecting line. In particular, the connecting line can be part of the brake circuit. A service brake can be understood to be a brake which acts on all the wheels of the commercial vehicle. The service brake also acts, for example via the first two control connectors on the trailer control module, on the service brake of the trailer vehicle, the third control connector being provided for actuating the trailer via the parking brake of the commercial vehicle. The service brake can comprise, for example, separate brake circuits for a front axle and a rear axle of the commercial vehicle. The distributor unit can be a component with an air inlet for the inlet of the controlled air and at least one outlet which is connected to the air inlet for connecting the distributor unit to the brake circuit. Depending on the embodiment, the distributor unit can have a plurality of outlets for connecting the distributor unit to a plurality of brake circuits, for instance also to a parking brake circuit or trailer brake circuit. Said embodiment can ensure reliable loading of the control valve connector with the setpoint pressure. Furthermore, as a result, a comparatively simple integration of the loading valve into the pneumatic system of the air control unit is made possible, which lowers the production costs of the air control unit. In electronic air control systems, a third circuit can also be used which is used firstly with respect to the parking brake but secondly with respect to the supply of the trailer control module. The supply of the trailer control module also supplies the trailer with air for the use of the service brake.

In addition, the control unit can be configured to actuate the loading valve or, in addition or as an alternative, the control valve in response to a failure of an electronic brake system of the commercial vehicle. As a result, sufficient braking performance of the brake system can be ensured in the case of a failure of the electronic brake system.

Furthermore, the approach which is proposed here provides a brake system having the following features:
an air control unit in accordance with one of the above embodiments;
at least one control valve which is connected upstream of a wheel brake cylinder of the brake system for changing a brake pressure in the wheel brake cylinder; and
a shuttle valve with a first shuttle valve inlet, a second shuttle valve inlet and a shuttle valve outlet, the first shuttle valve inlet being connected to the control valve connector of the air control unit, the second shuttle valve inlet being connected to a brake circuit which is assigned to a service brake of the brake system, and the shuttle valve outlet being connected to the control valve.

A brake system of this type affords the advantage of a robust, inexpensive and simple attachment of the air control unit to the control valve. The shuttle valve can ensure, for example, that the respective greater pressure of the pressures which prevail at the shuttle valve inlets is forwarded to the control valve.

In accordance with one embodiment, the brake system can have a relay valve with an operating pressure inlet, an operating pressure outlet and a control inlet for controlling a throughflow between the operating pressure inlet and the operating pressure outlet with the use of the setpoint pressure. The air control unit can have a relay valve connector for providing an operating pressure for operating the brake system. Here, the operating pressure inlet can be connected to the relay valve connector, the operating pressure outlet can be connected to the first shuttle valve inlet, and the control inlet can be connected to the control valve connector. In the figures which are appended below, the relay valve connector corresponds at least to the outlet which is present, for example, in an air control system to one of the two service brake circuits. The relay valve connector therefore corresponds, for example, to the supply outlet of the service brake circuit; the branch from said brake circuit for supplying the relay valve inlet is brought about, for example, outside the air control system by way of an additional tapping point from the pipework of said brake circuit.

In accordance with a further embodiment, the brake system can have a relay valve with an operating pressure inlet, an operating pressure outlet and a control inlet for controlling a throughflow between the operating pressure inlet and the operating pressure outlet with the use of a pressure which is provided at the shuttle valve outlet. The air control unit can have a relay valve connector for providing an operating pressure for operating the brake system. Here, the operating pressure inlet can be connected to the relay valve connector, the operating pressure outlet can be connected to the control valve, and the control inlet can be connected to the shuttle valve outlet. As a result, an actuation of the relay valve via the shuttle valve is made possible.

Furthermore, the best possible controllability of the service brake system is to be implemented, which means that the brake forces upstream of the ABS control valves should be capable of being set completely freely for each axle, depending on the loading of the vehicle, in further embodiments of the approach which is proposed here. In comparison with this, the brake force ratio between the front axle and the rear axle is fixed via a predefined pneumatic characteristic of the foot brake module in accordance with a further approach, with the result that the brake force ratio can sometimes not be optimum, both for the laden vehicle (high load on the rear axle, high brake pressure on the rear axle) and for the empty vehicle (low load on the rear axle=low brake pressure).

Furthermore, one embodiment of the approach which is proposed here is favorable, in the case of which the brake system is configured to actuate in each case one loading valve per axle by the air control unit.

Furthermore, one embodiment of the approach which is proposed here is advantageous, in the case of which the brake system is configured to actuate in each case one relay valve per axle in order to provide required volumetric flows. In the figures which are described in greater detail in the following text, said two relay valves are usually shown, firstly the addressed relay valve 134 for the front axle, and a second relay valve for the rear axle, which second relay valve leads to the parking brake cylinders.

Furthermore, one embodiment of the approach which is proposed here is conceivable, in the case of which the loading valves and/or the relay valves are arranged outside or inside the air control unit, but can be actuated by the air control unit.

Furthermore, one embodiment is favorable, in which at least one of the loading valves and/or at least one of the relay valves are/is configured to be operated in a monostable or bistable state. This is particularly advantageous by virtue of the fact that, in contrast to the service brake which carries out braking of the service brake cylinder with pressure, the parking brake usually brakes the spring force accumulator of the parking brake cylinder in a pressureless manner with inverted pressure conditions, and is bistable when driving and parking. Said parking brake is usually seated only on the rear axle. However, for example, there are also vehicles with parking brake cylinders on the front axle. The two brake concepts of the service brake and the parking brake should be capable of being implemented from the air control system both on the front axle and on the rear axle, and should possibly be of bistable configuration.

It is particularly advantageous to configure the brake system in such a way that a braking operation is capable of being stepped.

Furthermore, one embodiment of the approach which is proposed here is advantageous, in the case of which at least two electric redundancy systems or redundant systems for controlling a service brake are provided. In theory, the EBS system might also represent the backup if the fully functional electric service brake which is controlled in the normal case by the air control system fails.

Furthermore, in accordance with a further embodiment, the brake system can be configured to perform an actuation of a service brake function, which actuation can be stepped, in a manner which is independent of the driver request or in a manner which dominates the driver request.

In a further embodiment, the air control unit can also have a control unit for calculating the setpoint pressure for a service brake system in a manner which is based on read sensor information of a driver assistance system.

Furthermore, one embodiment of the approach which is proposed here is advantageous, in the case of which the brake system has an air control unit which is configured to additionally carry out a pneumatic, redundant control of the service brake in a manner which is dependent on the driver's brake request via the foot brake module. An increased safety of the proposal approach can thereby be achieved.

Furthermore, the approach which is proposed here provides a method for operating an air control unit in accordance with one of the above embodiments, the method comprising the following step:
generating of a control signal, in order to actuate the loading valve in such a way that the control valve connector is loaded with the setpoint pressure.

A computer program product or computer program with program code is also advantageous, which can be stored on a machine-readable carrier or storage medium such as a semiconductor memory, a hard drive memory or an optical memory, and is used to carry out, implement and/or actuate the steps of the method in accordance with one of the above-described embodiments, in particular if the program product or program is carried out on a computer or an apparatus.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a diagrammatic illustration of a brake system with an air control unit in accordance with one embodiment of the present invention.

FIG. 2 shows a diagrammatic illustration of a brake system with an air control unit in accordance with one embodiment of the present invention.

FIG. 3 shows a diagrammatic illustration of a brake system with an air control unit in accordance with one embodiment of the present invention.

FIG. 4 shows a diagrammatic illustration of a control unit in accordance with one embodiment of the present invention.

FIG. 5 shows a flow chart of a method in accordance with one embodiment of the present invention.

### DETAILED DESCRIPTION OF THE DRAWINGS

In the following description of favorable embodiments of the present invention, identical or similar designations are used for the similarly acting elements which are shown in the various figures, a repeated description of said elements being dispensed with.

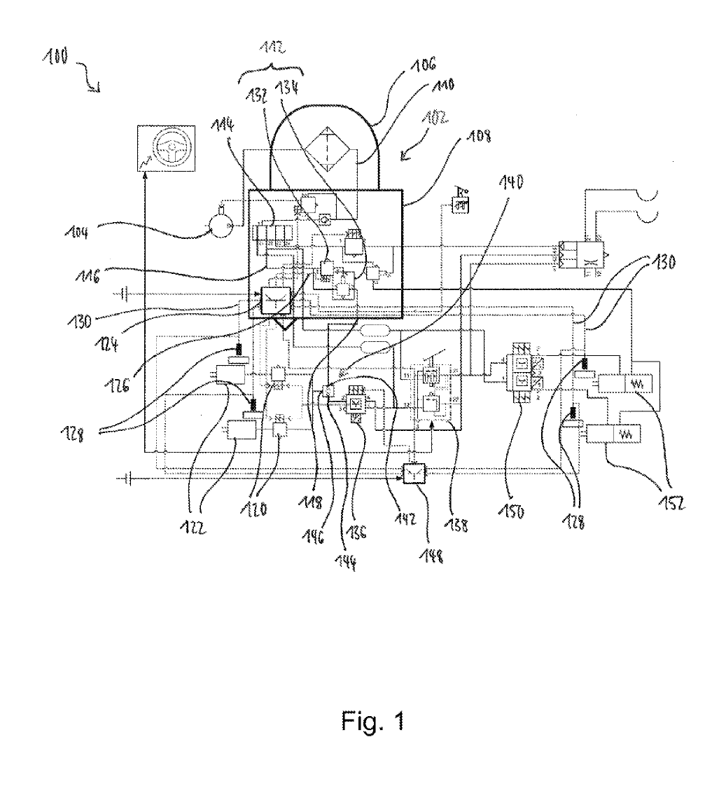

FIGS. 1 to 3 which are described in the following text indicate lines for electric signal transmission by way of dotted lines, pneumatic lines by way of continuous lines, and lines for the transmission of electric energy by way of arrow-shaped lines. Optional connections are indicated by way of lines which are partially dashed and partially dotted.

FIG. 1 shows a diagrammatic illustration of a brake system 100 for a commercial vehicle with an air control unit 102 in accordance with one exemplary embodiment. The air control unit 102 comprises a filter cartridge 106 which is connected to a compressor 104 for filtering and drying the compressed air which is provided by the compressor 104. The filter cartridge 106 is arranged on a housing 108 of the air control unit 102, and is connected pneumatically via a filter cartridge line 110 to the housing 108. A loading valve 112 is arranged in the housing 108. In accordance with said embodiment, the loading valve 112 is connected via a distributor unit 114 to the filter cartridge line 110. A connecting line 116 connects the distributor unit 114 to a control valve connector 118 of the housing 108. Here, the loading valve 112 is arranged in the connecting line 116. The pressure tapping point can also be arranged upstream of the distributor unit 114 for advantageous functioning. It is important in accordance with one embodiment that the supply pressure for the loading valve is stable, that is to say does not drop to zero in the case of an absent compressor delivery. Therefore, the pressure tapping point in said embodiment can also still lie between the distributor unit and the check valve. By way of example, the connecting line 116 is part of a brake circuit which is assigned to a service brake of the brake system 100. The air control unit 102 is coupled pneumatically via the control valve connector 118 by way of example to two control valves 120 which are connected upstream of in each case one of two front wheel brake cylinders 122 of a front axle of the commercial vehicle. In accordance with a further embodiment, the control valve connector 118 is coupled, as an alternative or in addition, to control valves which are assigned to a rear wheel brake of the commercial vehicle.

The loading valve 112 is configured to load the control valve connector 118 with a setpoint pressure. A control unit 124 which is likewise arranged on the housing 108 is configured to actuate the loading valve 112 by way of the output of a corresponding control signal 126. The control valves 120 are configured to change a respective brake pressure in the front wheel brake cylinders 122. The actuation of the control valves 120 by way of the air control unit 102 takes place, for example, in such a way that locking of the wheels during braking is prevented or the commercial vehicle is braked on one side.

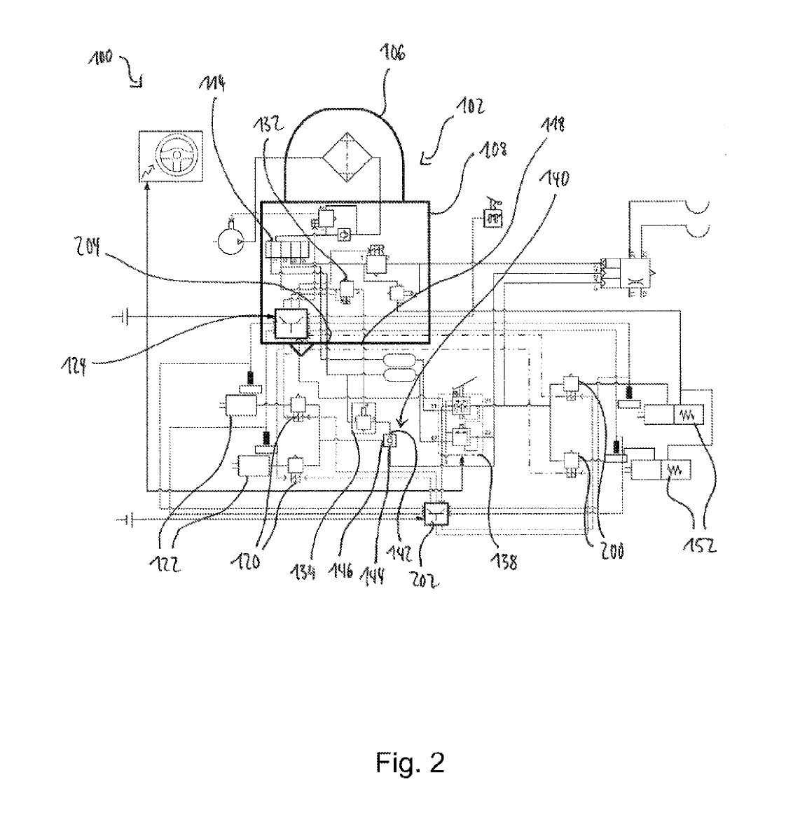

In accordance with said embodiment, the loading valve 112 is configured to load the control valve connector 118 with a setpoint pressure which can be modulated such that it can be stepped between the ambient pressure and the operating pressure, it being possible, for example, for said setpoint pressure to be removed in part directly from the solenoid valve and in part from a relay valve in a manner with a boosted air quantity. As an alternative, the loading valve 112 can be configured to load the control valve connector 118 with a control pressure (as the setpoint pressure) for pneumatically actuating a valve or valve module, connected upstream of the two control valves 120, of the brake system 100, such as a relay valve, as described in greater detail, for example, in the following text using FIG. 2.

By way of example, the commercial vehicle is equipped with a total of four optional wheel speed sensors 128 for detecting a rotational speed of in each case one wheel on the front and rear axle. The wheel speed sensors 128 send in each case one wheel speed sensor signal 130 which represents the respective rotational speed of a wheel to the control unit 124, the control unit 124 being configured to actuate the loading valve 112 with the use of the wheel speed sensor signals 130, that is to say in a manner which is dependent on the respective rotational speed of the wheels. The control unit 124 optionally uses the wheel speed sensor signals 130 to directly electrically actuate the two control valves 120, in addition or as an alternative to the loading valve 112, in particular in such a way that, during braking of the commercial vehicle, locking of the front wheels is avoided or the commercial vehicle is additionally braked on one side.

In accordance with the embodiment which is shown in FIG. 1, the loading valve 112 is realized as a valve module comprising a plurality of individual valves, here comprising a solenoid valve 132 with (by way of example) two solenoid valve units, and a relay valve 134. The relay valve 134 comprises an operating pressure inlet 1, an operating pressure outlet 2 and a control inlet 4 for controlling a throughflow between the operating pressure inlet 1 and the operating pressure outlet 2. Here, the operating pressure inlet 1 is connected via the connecting line 116 to the distributor unit 114, with the result that the setpoint pressure prevails in the form of the operating pressure at the operating pressure inlet 1. The operating pressure outlet 2 is connected to the control valve connector 118. The control inlet 4 is connected to an outlet 2 of the solenoid valve unit 132. Said solenoid valve arrangement has, for example, two solenoid valves which are required to realize pressure maintaining, pressure build-up and pressure dissipation. An illustration of this type is not shown explicitly in the figures for the sake of clarity. The solenoid valve unit 132 is configured to load the control inlet 4, using the setpoint pressure (here, the operating pressure), with a control pressure which is, for example, considerably lower for opening the relay valve 134, with the result that the setpoint pressure prevails at the control valve connector 118. The electric actuation of the solenoid valve 132 takes place by way of the control unit 124.

In accordance with one embodiment, the loading unit 112 is of bistable configuration. This can ensure that the setpoint pressure prevails at the control valve connector 118 even in the case of an interrupted power supply. The bistable valves can be bistable, for example, at maximum pressure or zero pressure. In this way, they are suitable for maintaining the two pressure states of a parking brake without power. Therefore, any desired setpoint pressure cannot be maintained without power. The bistable valve unit will regulate, for example, into one of the pressure end positions.

The two front wheel brake cylinders 122 are connected via a front axle valve module 136 to a foot brake module 138 of the brake system 100. The two control valves 120 are arranged between the front wheel brake cylinders 122 and the front axle valve module 136. In a line section which connects the two control valves 120 to the front axle valve module 136, a shuttle valve 140 is arranged with a first shuttle valve inlet 142, a second shuttle valve inlet 144 and a shuttle valve outlet 146. Here, the first shuttle valve inlet 142 is connected to the control valve connector 118, the second shuttle valve inlet 144 is connected to an outlet of the front axle valve module 136 and therefore to a brake circuit which is assigned to a service brake of the brake system 100, and the shuttle valve outlet 146 is connected to the two control valves 120. The shuttle valve 140 can ensure that the two control valves 120 are loaded in each case with the higher one of the pressures which prevail at the two shuttle valve inlets 142, 144.

The brake system 100 which is shown in FIG. 1 can be actuated by way of example by an EBS control unit 148 of an electronic brake system of the commercial vehicle. To this end, the EBS control unit 148 is connected, for example, to the wheel speed sensors 128, the foot brake module 138 and the front axle valve module 136 for electric signal transmission. In accordance with one embodiment, the control unit 124 of the air control unit 102 is configured to actuate the loading valve 112 in the case of failure of the electronic brake system, with the result that sufficient braking performance can still be ensured at the front axle of the commercial vehicle.

Furthermore, the foot brake module 138 is connected via a rear axle valve module 150 to two rear wheel brake cylinders 152 of the rear axle of the commercial vehicle. Merely by way of example, no ABS control valves are arranged between the rear axle valve module 150 and the rear wheel brake cylinders 152 in contrast to the front axle. In accordance with said embodiment, the two rear wheel brake cylinders 152 are configured to lock the rear wheels of the commercial vehicle by spring force in the ventilated state. The rear wheel brake cylinders 152 therefore act as a park or parking brake.

FIG. 2 shows a diagrammatic illustration of a brake system 100 for a commercial vehicle with the air control unit 102 in accordance with one embodiment. The brake system 100 corresponds substantially to the brake system described in the preceding text using FIG. 1. In contrast to FIG. 1, the brake system 100 in FIG. 2 is shown without a front and rear axle valve module. Instead, the foot brake module 138 is coupled to the two rear wheel brake cylinders 152 via two further control valves 200 which are connected upstream of the two rear wheel brake cylinders 152. Just like the two control valves 120 of the front axle, the two further control valves 200 of the rear axle act as ABS pressure control valves. In the normal case, the electric actuation of the four control valves 120, 200 takes place by way of an ABS control unit 202. As an alternative, in the case of the failure of the ABS control unit 202, the four control valves 120, 200 can be actuated by the control unit 124 of the air control unit 102. As an alternative or in addition to the visible relay valve of the parking brake, a relay valve might also be used at the rear axle, in order for it to be possible for a redundant pressure specification for the service brake cylinders of the rear axle to be modulated at the rear axle via a further valve 144 upstream of the control valves in an analogous manner to the pressure at the front axle (maximum upgrade).

A further difference from FIG. 1 consists in that the relay valve 134 is arranged outside the housing 108 here. Here, the operating pressure inlet 1 is connected to a relay valve connector 204 of the housing 108, which relay valve connector 204 is connected to the distributor unit 114, with the result that the operating pressure inlet 1 is loaded with the operating pressure via the relay valve connector 204. The operating pressure outlet 2 is connected to the first shuttle valve inlet 142, whereas the control inlet 4 is connected to the control valve connector 118. The first shuttle valve inlet 122 is therefore connected via the relay valve 134 to the control valve connector 118. The outlet 2 of the solenoid valve 132 which is situated in the housing 108 is likewise connected to the control valve connector 118 and is configured to load the control inlet 4 via the control valve connector 118 with the control pressure which is required for the pneumatic control of the relay valve 134 as the setpoint pressure. The second shuttle valve inlet 144 is connected to the foot brake module 138 and therefore to a service brake circuit of the brake system 100. As in FIG. 1, the shuttle valve outlet 146 is connected to the two control valves 120 of the front axle.

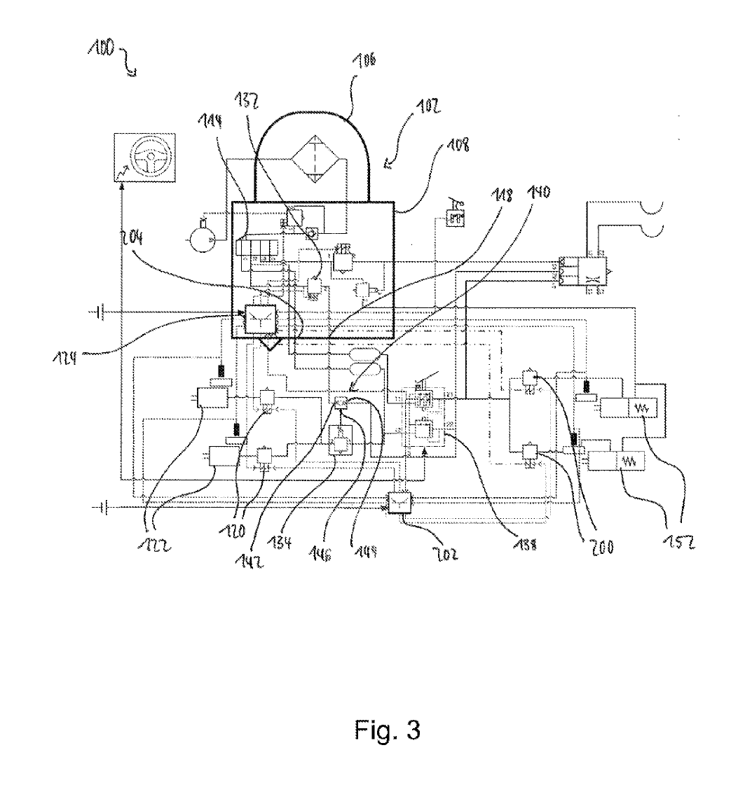

FIG. 3 shows a diagrammatic illustration of a brake system 100 for a commercial vehicle with an air control unit 102 in accordance with one embodiment. The brake system 100 which is shown in FIG. 3 corresponds for the most part to the brake system which is described in the preceding text using FIG. 2, with the difference that the relay valve 134 is arranged here between the shuttle valve 140 and the two control valves 120 instead of between the control valve connector 118 and the shuttle valve 140 as in FIG. 2. Here, as in FIG. 1, the first shuttle valve inlet 142 is connected directly to the control valve connector 118, whereas the second shuttle valve inlet 144 is connected to the foot brake module 138. The control inlet 4 of the relay valve 134 is connected to the shuttle valve outlet 146. The pneumatic actuation of the relay valve 134 therefore takes place indirectly via the shuttle valve 140. Here, the operating pressure inlet 1 is connected to the relay valve connector 204, and the operating pressure outlet 2 is connected to the two control valves 120.

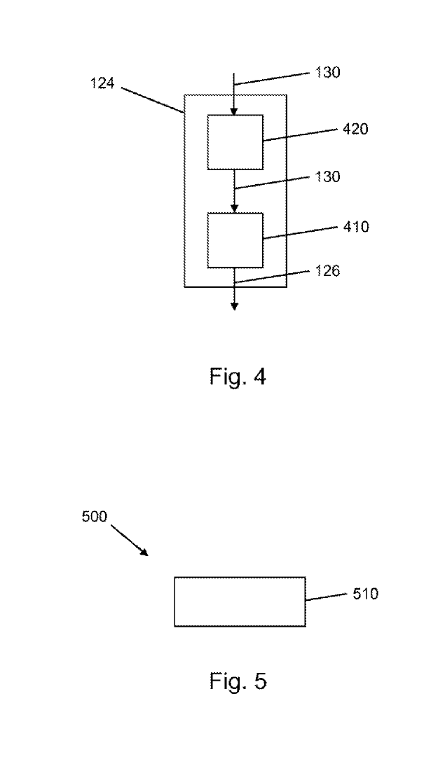

FIG. 4 shows a diagrammatic illustration of a control unit 124 in accordance with one embodiment, for instance of a control unit which is described in the preceding text using FIGS. 1 to 3. The control unit 124 comprises a generating unit 410 for generating the control signal 126. The control unit 124 optionally comprises a reading unit 420 for reading the wheel speed sensor signals 130 and forwarding the wheel speed sensor signals 130 to the generating unit 410. Here, the generating unit 410 is configured to generate the control signal 126 with the use of the wheel speed sensor signals 130.

FIG. 5 shows a flow chart of a method 500 for operating an air control unit in accordance with one embodiment. The method 500 can be carried out, for example, in conjunction with a control unit which is described in the preceding text using FIGS. 1 to 4. The method 500 comprises a step 510, in which the control signal for actuating the loading valve of the air control unit is generated.

In the following text, different embodiments of the approach which is proposed here are summarized once again in other words.

The setpoint pressure of the brake system 100 is as a rule transmitted via the foot brake module 138 to the two brake circuits of the front and rear axle. Here, the pressure ratio of the front axle to the rear axle is fixed pneumatically via the foot brake module 138. That is to say, the two axles cannot be modulated at the same time in an optimum manner to the slip in some circumstances. Even in the ABS case, the pilot pressure upstream of the ABS pressure control valves (also called control valves for short in the preceding text) can be sub-optimally high, for instance, on one of the two axles.

Using the approach which is proposed here, it is then possible, during autonomous driving, to modulate the setpoint pressure which is provided by the air control unit 102 in parallel with the electronic brake system upstream of the ABS pressure control valves per axle in the case of a failure of the electronic brake system. In this way, an optimum distribution of the brake forces to the axles, which brake forces can vary greatly in a manner which is dependent on a load-induced contact force, and therefore as short a braking distance as possible can be ensured.

The control unit 124 is optionally configured to read the wheel speed sensor signals 130, for instance pole wheel signals, in parallel with the electronic brake system. With a knowledge of the wheel slip, the control unit 124 then modulates to a maximum permissible slip of the wheel with a lower coefficient of friction at least per axle, in a similar manner to an anti-lock brake system.

In accordance with a further embodiment, the ABS pressure control valves are connected electrically to the control unit 124 for actuation in the case of a failure of the electronic brake system. As a result, it is possible to modulate to the slip in a wheel-individual manner, which can shorten the braking distance, in particular in the case of friction conditions which fluctuate from side to side. The air control unit 102 is likewise given the option as a result to perform steering/braking operations by way of one-sided breaking of the steered axle.

In accordance with one embodiment, the loading valve 112 comprises a solenoid valve unit 132 with at least two solenoid valves which are additionally integrated into the air control unit 102 and are configured to feed the control air via the relay valve 134 in a manner with a boosted air quantity via a select high valve into a line branch upstream of the ABS pressure control valves. Depending on the embodiment, the relay valve 134 is integrated into the air control unit 102 or is arranged outside the air control unit 102.

In the case of an anti-lock brake system, an anti-slip control valve (equivalent to proportional valves or differential pressure valves with the same function) can be saved by way of an extension of this type of the air control unit 102 if the air control unit 102 can transmit the supply pressure via the anti-slip control valves to the drive wheels during the anti-slip control operation, even in the normal case.

A functional extension for increasing the stability of the commercial vehicle consists, for example, in that the loading valve 112 for actuating the front axle is of bistable configuration, with the result that the brake pressure is maintained at the front axle even in the case of a power failure or after the ignition is switched off. This might still hold the vehicle at a standstill in an emergency situation if the rear axle has come to a standstill merely at a low level.

Depending on the embodiment, the actuation of the brake system 100 via the air control unit 102 is realized on one or more axles of the commercial vehicle. It is advantageous here if, instead of a dual channel pressure control module, a single channel pressure control module with downstream ABS pressure control valves is installed at the rear axle, with the result that side-individual brake intervention via the air control unit 102 can take place even at the rear axle in the case of a failure of the electronic brake system.

In the case of an extension of the actuation to the axles of the commercial vehicle which are equipped with parking brake cylinders, the brake actuation shown here of the rear axle via a parking brake can then be dispensed with. In this way, the parking brake can be decoupled from the redundancy function for autonomous driving.

The embodiment which is shown in FIG. 3 is advantageous with regard to clear spans to be designed and robustness in so far as only control flows are conducted via the select high valve.

If an embodiment comprises an “and/or” combination between a first feature and a second feature, this is to be interpreted such that the exemplary embodiment has both the first feature and the second feature in accordance with one embodiment, and has either only the first feature or only the second feature in accordance with a further embodiment.

### LIST OF DESIGNATIONS

1 Operating pressure inlet
2 Operating pressure outlet
4 Control inlet
100 Brake system
102 Air control unit
104 Compressor
106 Filter cartridge
108 Housing
110 Filter cartridge line
112 Loading valve
114 Distributor unit
116 Connecting line
118 Control valve connector
120 Control valve
122 Front wheel brake cylinder
124 Control unit
126 Control signal
128 Wheel speed sensor
130 Wheel speed sensor signal
132 Solenoid valve
134 Relay valve
136 Front axle valve module
138 Foot brake module
140 Shuttle valve
142 First shuttle valve inlet
144 Second shuttle valve inlet
146 Shuttle valve outlet
148 EBS control unit
150 Rear axle valve module
152 Rear wheel brake cylinder
200 Further control valve
202 ABS control unit
204 Relay valve connector
410 Generating unit
420 Reading unit
500 Method for operating an air control unit
510 Generating step

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An air control unit for a brake system of a commercial vehicle, comprising:
a control valve connector configured to pneumatically couple the air control unit to a control valve upstream of a wheel brake cylinder of the brake system;
a loading valve configured to load the control valve connector with a setpoint pressure; and
a control unit configured to actuate the loading valve to change a brake pressure in the wheel brake cylinder.

2. The air control unit as claimed in claim 1, wherein
the control unit is configured to
be coupled to at least one wheel speed sensor of the commercial vehicle, and
actuate either or both of the loading valve and the control valve based at least in part on a wheel speed sensor signal generated by the wheel speed sensor to brake one side of the commercial vehicle.

3. The air control unit as claimed in claim 2, further comprising:
a distributor unit configured to distribute air from the air control unit to a brake circuit of a service brake of the brake system;
a connecting line configured to connect the distributor unit to the control valve connector; and
a shuttle valve having a first shuttle valve inlet and a second shuttle valve inlet,
wherein
the connecting line is part of the brake circuit,
the loading valve is arranged in the connecting line and upstream of the first shuttle valve inlet such that the loading valve is capable of actuating the service brake via the shuttle valve to control one or both of an outlet control pressure of a front or rear axle valve module and an outlet control pressure of the foot brake module at the second shuttle valve inlet.

4. The air control unit as claimed in claim 3, wherein
the control unit is configured to actuate one or both of the loading valve and the control valve in response to a failure of an electronic brake system of the commercial vehicle.

5. A brake system, comprising:
an air control unit including
a control valve connector configured to pneumatically couple the air control unit to a control valve upstream of a wheel brake cylinder of the brake system;
a loading valve configured to load the control valve connector with a setpoint pressure; and
a control unit configured to actuate the loading valve to change a brake pressure in the wheel brake cylinder;
a control valve configured to change a brake pressure in a wheel brake cylinder of the brake system; and
a shuttle valve having a first shuttle valve inlet, a second shuttle valve inlet (144) and a shuttle valve outlet, the first shuttle valve inlet being connected to the control valve connector of the air control unit, the second shuttle valve inlet being connected to a brake circuit of a service brake of the brake system, and the shuttle valve outlet being connected to the control valve.

6. The brake system claimed in claim 5, further comprising:
a relay valve having an operating pressure inlet, an operating pressure outlet and a control inlet,
wherein
the relay valve is configured to control a throughflow between the operating pressure inlet and the operating pressure outlet at a setpoint pressure,
the air control unit has a relay valve connector configured to provide an operating pressure for operating the brake system,
the relay valve operating pressure inlet is connected to the relay valve connector,
the relay valve operating pressure outlet is connected to the first shuttle valve inlet, and
the relay valve control inlet being connected to the control valve connector.

7. The brake system as claimed in claim 5, further comprising:
a relay valve having an operating pressure inlet, an operating pressure outlet and a control inlet,
wherein
the relay valve is configured to control a throughflow between the operating pressure inlet and the operating pressure outlet at a pressure at the shuttle valve outlet,
the air control unit has a relay valve connector configured to provide an operating pressure for operating the brake system,
the relay valve operating pressure inlet is connected to the relay valve connector,
the relay valve operating pressure outlet is connected to the control valve, and
the relay valve control inlet being connected to the shuttle valve outlet.

8. The brake system as claimed in claim 5, wherein
the loading valve is one of a plurality of loading valves, each loading valve being associated with a respective axle, and
the system is configured to actuate the plurality of loading valves on a per axle basis.

9. The brake system as claimed in claim 8, wherein
the plurality of loading valves are arranged outside or inside the air control unit, and are actuable by the air control unit.

10. The brake system as claimed in claim 5, wherein
the relay valve is one of a plurality of relay valves, each relay valve being associated with a respective axle, and
the system is configured to actuate in the plurality of relay valves on a per axle basis.

11. The brake system as claimed in claim 10, wherein
the plurality of relay valves are arranged outside or inside the air control unit, and are actuable by the air control unit.

12. The brake system as claimed in claim 8, wherein
the plurality of loading valves are configured to be bistable.

13. The brake system as claimed in claim 10, wherein
the plurality of relay valves are configured to be bistable.

14. The brake system as claimed in claim 5, wherein
the brake system is configured to control a braking operation in a stepped manner.

15. The brake system as claimed in claim 5, wherein
at least two electric redundancy systems are provided for controlling the service brake.

16. The brake system as claimed in claim 5, wherein
the brake system is configured to actuate the service brake in a stepped manner, both independent of a driver request and in a manner which dominates the driver request.

17. The brake system as claimed in claim 5, wherein
the control unit is configured to calculate the setpoint pressure for a service brake system based at least in part of information from a driver assistance system.

18. The brake system as claimed in claim 5, wherein
the air control unit is configured to additionally carry out a pneumatic, redundant control of the service brake in a manner which is dependent on a driver brake request via a foot brake module.

19. A method for operating an air control unit having a control valve connector configured to pneumatically couple the air control unit to a control valve upstream of a wheel brake cylinder of the brake system, a loading valve configured to load the control valve connector with a setpoint pressure, and a control unit configured to actuate the loading valve to change a brake pressure in the wheel brake cylinder, the method comprising the act of:
generating a control signal to actuate the loading valve to load the control valve connector with the setpoint pressure.

20. A machine-readable storage medium, on which a computer program configured to carry out and/or actuate the method as claimed in claim 19 is stored.
